(19) United States
(12) Patent Application Publication
(10) Pub. No.: US 2005/0215433 A1
(43) Pub. Date: Sep. 29, 2005

(54) Aromatic fluid as agricultural solvent

(76) Inventors: Francisco Manuel Benitez, Houston, TX (US); John Scott Buchanan, Lambertville, NJ (US); Martin A. Krevalis, Houston, TX (US); Steven Earl Silverberg, Seabrook, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/073,088

(22) Filed: Mar. 4, 2005

Related U.S. Application Data
(60) Provisional application No. 60/556,827, filed on Mar. 26, 2004.

(51) Int. Cl. A01N 43/40; A01N 33/00; A01N 25/02; A01N 37/34

(52) U.S. Cl. 504/254; 504/362; 504/326; 514/521

(57) ABSTRACT

A composition that comprises a pesticide and an aromatic fluid. A method of preparing a pesticide emulsion that comprises combining a pesticide and an aromatic fluid to form a composition, blending that composition with a surfactant component to form an emulsifiable pesticide concentrate, and mixing that emulsifiable pesticide concentrate with water to form the pesticide emulsion. A method of applying the pesticide emulsion that comprises dispersing the pesticide emulsion onto a crop. A method for inhibiting pests that comprises applying the pesticide emulsion to a crop.

### CROSS-REFERENCE TO RELATED APPLICATIONS

The present application claims the benefit of U.S. Provisional Application No. 60/556827, filed Mar. 26, 2004, which is hereby incorporated by reference.

### FIELD OF INVENTION

The present invention generally relates to the field of agricultural chemicals. More particularly, the present invention relates to fluids for pesticide compositions.

### BACKGROUND OF THE INVENTION

A wide variety of pesticides are used in the agricultural chemical industry. An equally varying number of solvents should be available to meet the demands of the industry.

U.S. Pat. No. 5,459,122 discloses an agricultural pesticide or herbicide formulation that comprises an effective amount of a pesticide or herbicide in a carrier or solvent fluid. The carrier or solvent fluid is an aromatic oil that has an aniline point less than 120° F.; a mutagenicity index based on The Modified Ames Test of less than 2.0; concentrations of benzene, naphthalene, and methyl substituted benzenes and napthalenes of less than 100 wppm; and a clay gel aromatics fraction content of at least 50 weight % based on the aromatic oil. The aromatics fraction is characterized in that it has a naphthenebenzenes and dinaphthenbenzenes content of at least 50 weight % based on the aromatics fraction.

Current solvents used in the agricultural chemical industry include Aromatic 100, Aromatic 150, and Aromatic 200 fluid products, available from ExxonMobil Chemical Company. Aromatic 100 fluid comprises a mixture of components with some of the principle components comprising alkylbenzenes having 9 to 10 carbon atoms, the alkyl groups primarily being methyl and ethyl groups, and some of the principle components comprising propylbenzene (5 weight %), ethylmethylbenzenes (28 weight %), 1,3,5-trimethylbenzene (10 weight %), and 1,2,4-trimethylbenzene (32 weight %).

Aromatic 150 fluid comprises approximately fifty components with some of the principle components comprising about 1.7 weight % of 1,2,4-trimethylbenzene; about 3.0 weight % of 1,2,3-trimethylbenzene and meta-cumene; a mixture of about 81.6 weight % C₁₀ to C₁₂ benzene compounds, having one or more substituents selected from methyl, ethyl, propyl, and butyl; about 8.6 weight % naphthalene; and about 0.3 weight % methylnaphthalene.

Aromatic 200 fluid comprises approximately 25 to 30 components with some of the principle components comprising naphthalene (10 weight %); various alkylnaphthalenes (75 weight %), including 2-methylnaphthalene (26 weight %), 1-methylnaphthalene (13 weight %), 2-ethylnaphthalene (2 weight %), dimethyl naphthalenes (18 weight %), and trimethyl naphthalenes (7 weight %); and the remaining 15 weight % comprises primarily alkylbenzenes, as determined by gas chromatographic analysis.

There is a limited supply of Aromatic 100, Aromatic 150, and Aromatic 200 fluid products, therefore a need exists for alternative solvents that meet demands. Surprisingly, solubility results showed that pesticides were more soluble in a cycloalkyl substituted mono-nuclear aromatic fluid than in other mixed aromatic/paraffinic fluids, and pesticides were as soluble in a cycloalkyl substituted mono-nuclear aromatic fluid as in other currently available solvents.

### SUMMARY OF THE INVENTION

The present invention relates to an aromatic fluid having a cycloalkyl group as an alternative solvent for use in agricultural chemicals.

One embodiment according to the present invention provides a composition comprising a pesticide and an aromatic fluid having a chemical composition described by Formula I: 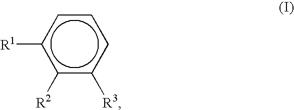
wherein R¹ is a cycloalkyl group having from 4 to 10 carbon atoms and optionally having one or more alkyl group substitutions each having from 1 to 4 carbon atoms; R² is a hydrogen, or an alkyl group having from 1 to 4 carbon atoms; and R³ is a cycloalkyl group having from 4 to 10 carbon atoms and optionally having one or more alkyl group substitutions each having from 1 to 4 carbon atoms, a hydrogen, or an alkyl group having from 1 to 4 carbon atoms.

Another embodiment according to the present invention provides a method for inhibiting pests comprising combining a pesticide in an aromatic fluid having a chemical composition described by Formula I above to form a composition. The composition can then be blended with a surfactant component to form an emulsifiable pesticide concentrate. The emulsifiable pesticide concentrate can then be mixed with water to form a pesticide emulsion, and applying the pesticide emulsion to a crop.

Another embodiment according to the present invention provides a method of preparing a pesticide emulsion comprising mixing water with an emulsifiable pesticide concentrate that comprises a surfactant component and a composition comprising a pesticide and an aromatic fluid having a chemical composition described by Formula I above.

Another embodiment according to the present invention provides a method of applying a pesticide emulsion comprising dispersing the pesticide emulsion that comprises a pesticide, an aromatic fluid having a chemical composition described by Formula I above, a surfactant component, and water onto a crop.

### DETAILED DESCRIPTION OF THE PREFERRED EMBODIMENTS

The present invention is directed to a composition having a pesticide and an aromatic fluid.

### Specific Embodiments

Certain specific embodiments are described below. Various terms in the claims are defined herein. To the extent a term used in a claim is not defined below, or elsewhere herein, it should be given the broadest definition persons in the pertinent art have given that term as reflected in printed publications and issued patents.

Aromatic Fluids

Pesticides are frequently applied as emulsifiable pesticide concentrates. The active pesticide is dissolved in a solvent. The emulsifiable pesticide concentrate also contains an emulsifier, such as a surfactant component. The solvent should have adequate solvency for the pesticide, promote good dispersion when diluted with water, have low toxicity and a flash point high enough to minimize flammability hazards.

As used herein the term “fluid” includes material that may function as one or more of a carrier, diluent, a surface tension modifier, dispersant, and the like, as well as a material functioning as a solvent, in the traditional sense of a liquid which solvates a substance.

The aromatic fluid of the invention having a chemical composition described by Formula I: 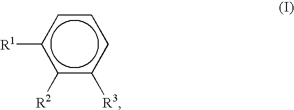
wherein R¹ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom;
R² is a hydrogen, or
an alkyl group having from 1 to 4 carbon atoms, alternatively a carbon atom; and
R³ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom,
a hydrogen, or
an alkyl group having from 1 to 4 carbon atoms, alternatively 1 carbon atom.

In another embodiment, the aromatic fluid of the invention having a chemical composition described by Formula II: 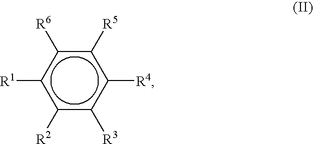
wherein R¹ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom;
R² is a hydrogen, or
an alkyl group having from 1 to 4 carbon atoms, alternatively a carbon atom;
R³ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom,
a hydrogen, or
an alkyl group having from 1 to 4 carbon atoms, alternatively 1 carbon atom;
R⁴ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom,
a hydrogen, or
an alkyl group having from 1 to 4 carbon atoms, alternatively 1 carbon atom;
R⁵ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom,
a hydrogen, or
an alkyl group having from 1 to 4 carbon atoms, alternatively 1 carbon atom; and
R⁶ is a cycloalkyl group having from 4 to 10 carbon atoms, alternatively from 5 to 7 carbon atoms, alternatively 6 carbon atoms, and optionally having one or more alkyl group substitutions each having from 1 to 4 carbon atoms, alternatively 1 carbon atom,
a hydrogen, or
an alkyl group having from 1 to 4 carbon atoms, alternatively 1 carbon atom;
   wherein no more than three cycloalkyl or alkylsubstituted cycloalkyl groups are present on the aromatic ring structure, alternatively no more than two cycloalkyl or alkylsubstituted cycloalkyl groups are present on the aromatic ring structure.

In another embodiment at least one of R² to R⁶ of Formula II is hydrogen. In another embodiment at least two of R² to R⁶ of Formula II is hydrogen.

In an embodiment, the aromatic fluid comprises C₁₂ compounds, including, but not limited to, cyclohexylbenzene, bicyclohexyl, and methylcyclopentylbenzene, from 10 weight % to 100 weight %, alternatively from 15 weight % to 90 weight %, alternatively from 20 weight % to 85 weight %, alternatively from 20 weight % to 80 weight %, alternatively from 25 weight % to 75 weight %, alternatively from 30 weight % to 70 weight %, alternatively from 40 weight % to 50 weight %. The mixture further comprises C₁₃ compounds, including, but not limited to, cyclohexyltoluene, methylcyclohexylbenzene, and dimethylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₄ compounds, including, but not limited to, methylcyclohexyltoluene, dimethylcyclohexylbenzene, and trimethylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₅₊ compounds, including, but not limited to, dicyclohexylbenzene and dimethylcyclohexylxylene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₁− compounds, including compounds having from 1 to 11 carbon atoms, from 0 weight % to 5 weight %, alternatively from 0 weight % to 1 weight %. The weight % of the aromatic fluid is based on the total weight of the C₁₂ compounds, C₁₃ compounds, C₁₄ compounds, C₁₅₊ compounds, and C₁₁₋ compounds.

In an embodiment, the aromatic fluid comprises C₁₃ compounds, including, but not limited to, cyclohexyltoluene, methylcyclohexylbenzene, and dimethylcyclopentylbenzene, from 10 weight % to 100 weight %, alternatively from 15 weight % to 90 weight %, alternatively from 20 weight % to 85 weight %, alternatively from 20 weight % to 80 weight %, alternatively from 25 weight % to 75 weight %, alternatively from 30 weight % to 70 weight %, alternatively from 40 weight % to 50 weight %. The mixture further comprises C₁₂ compounds, including, but not limited to, cyclohexylbenzene, bicyclohexyl, and methylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₄ compounds, including, but not limited to, methylcyclohexyltoluene, dimethylcyclohexylbenzene, and trimethylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₅₊ compounds, including, but not limited to, dicyclohexylbenzene and dimethylcyclohexylxylene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₁₋ compounds, including compounds having from 1 to 11 carbon atoms, from 0 weight % to 5 weight %, alternatively from 0 weight % to 1 weight %. The weight % of the aromatic fluid is based on the total weight of the C₁₂ compounds, C₁₃ compounds, C₁₄ compounds, C₁₅₊ compounds, and C₁₁₋ compounds.

In an embodiment, the aromatic fluid comprises C₁₄ compounds, including, but not limited to, methylcyclohexyltoluene, dimethylcyclohexylbenzene, and trimethylcyclopentylbenzene, from 10 weight % to 100 weight %, alternatively from 15 weight % to 90 weight %, alternatively from 20 weight % to 85 weight %, alternatively from 20 weight % to 80 weight %, alternatively from 25 weight % to 75 weight %, alternatively from 30 weight % to 70 weight %, alternatively from 40 weight % to 50 weight %. The mixture further comprises C₁₂ compounds, including, but not limited to, cyclohexylbenzene, bicyclohexyl, and methylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₃ compounds, including, but not limited to, cyclohexyltoluene, methylcyclohexylbenzene, and dimethylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₅₊ compounds, including, but not limited to, dicyclohexylbenzene and dimethylcyclohexylxylene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₁₋ compounds, including compounds having from 1 to 11 carbon atoms, from 0 weight % to 5 weight %, alternatively from 0 weight % to I weight %. The weight % of the aromatic fluid is based on the total weight of the C₁₂ compounds, C₁₃ compounds, C₁₄ compounds, C₁₅₊ compounds, and C₁₁₋ compounds.

In an embodiment, the aromatic fluid comprises C₁₅₊ compounds, including, but not limited to, dicyclohexylbenzene and dimethylcyclohexylxylene, from 10 weight % to 100 weight %, alternatively from 15 weight % to 90 weight %, alternatively from 20 weight % to 85 weight %, alternatively from 20 weight % to 80 weight %, alternatively from 25 weight % to 75 weight %, alternatively from 30 weight % to 70 weight %, alternatively from 40 weight % to 50 weight %. The mixture further comprises C₁₂ compounds, including, but not limited to, cyclohexylbenzene, bicyclohexyl, and methylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₃ compounds, including, but not limited to, cyclohexyltoluene, methylcyclohexylbenzene, and dimethylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₁₄ compounds, including, but not limited to, methylcyclohexyltoluene, dimethylcyclohexylbenzene, and trimethylcyclopentylbenzene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₉₋₁₁ compounds, including compounds having from 9 to 11 carbon atoms, from 0 weight % to 5 weight %, alternatively from 0 weight % to 1 weight %. The mixture further comprises C₈ compounds, including, but not limited to, xylene, from 0 weight % to 90 weight %, alternatively from 10 weight % to 85 weight %, alternatively from 15 weight % to 80 weight %, alternatively from 20 weight % to 80 weight %, alternatively from 25 weight % to 75 weight %, alternatively from 30 weight % to 70 weight %, alternatively from 50 weight % to 60 weight %. The mixture further comprises C₇₋ compounds, including compounds having from 1 to 7 carbon atoms, from 0 weight % to 5 weight %, alternatively from 0 weight % to 1 weight %. The weight % of the aromatic fluid is based on the total weight of the C₁₂ compounds, C₁₃ compounds, C₁₄ compounds, C₁₅₊ compounds, C₉₋₁₁ compounds, C₈ compounds, and C₇ compounds.

The Formula I includes any individual positional (regioisomer) isomer or combination of regioisomers formed, compound C. Although not wishing to be bound by any particular theory, it is believed that the compounds of Formula I form by partial reduction of one aromatic molecule, A, to form an unsaturated intermediate, B, which then alkylates an unhydrogenated aromatic molecule, A, as shown in Reaction Sequence 1.

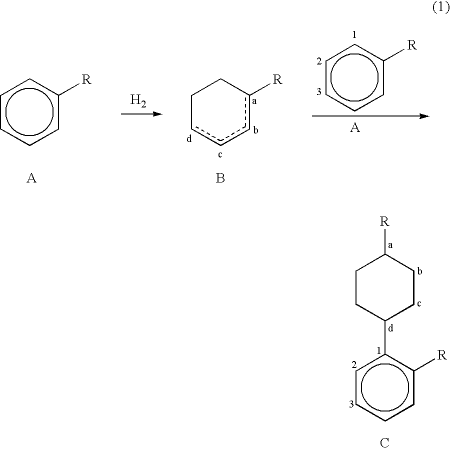

One of ordinary skill in the art appreciates that the alkylation of A with B could occur by bond formation between carbon atoms denoted 1, 2, and 3 of A with the carbon atoms denoted a, b, c and d of B. The Formula I represents any individual regioisomeric product C or combination of regioisomeric products formed by reaction of the intermediates B and A. The dotted line in B indicates that B may be one or more regioisomers in which a double bond is present between carbons a and b; carbons b and c; or carbons c and d. R is a hydrogen or a C₁-C₄ group.

One of ordinary skill in the art appreciates that the Reaction Sequence 1 can predict the type C products obtained when A is a single aromatic compound, with or without one or more alkyl substituents, or when A is a mixture of aromatic compounds, with or without one or more alkyl substituents. Exemplary aromatic compounds of type A include, but are not limited to, benzene, toluene, xylene, and mixtures thereof.

Pesticides

In one embodiment according to the present invention, the composition includes one or more pesticides. The pesticides include, but are not limited to, herbicides, insecticides, fungicides, acaricides, nematocides, miticides, rodenticides, bactericides, molluscicides, and bird repellents. The pesticides are used individually or in combination in the composition. The pesticides are used to inhibit pests, including, but not limited to, weeds, insects, fungi, mites, ticks, nematodes, rodents, bacteria, mollusks, and birds.

Herbicides useful in compositions are exemplified by, but are not limited to, amides such as dimethanamid, acetochlor, pretilachlor, metachlor, butachlor, alachlor, metolachlor, diethatyl, metazachlor, dimethachlor, propachlor, propanil, napropamide, mefluidide, isoxaben, dimethanamid, and naptalam; dichloroacetamide such as dichlormid; thiocarbamates such as butylate, cycloate, molinate, pebulate, thiobencarb, tri-allate, vernolate, and s-ethyl diethylcarbamathioate; dietholate; cyclohexene oxime such as sethoxydim and clethodim; phenoxy herbicides such as 2,4-dichlorophenoxyacetic acid (2,4-D), amine salts of 2,4-D, esters of 2,4-D, 3,4-DA (3,4 dichlorphenoxy acetic acid), 2,4-DB(4-(2,4-dichlorophenoxy)acetic acid), 3,4-DB (4(3,4)-dichlorphenoxy)butanoic acid), 2,4-DEB (2-(2,4-dichlorophenoxy)ethylbenzoate), 2,4-DEP (tris[2-(2,4-dichlorophenoxy)ethyl] phosphite), MCPA acid (4-chloro-2-methylphenoxy acetic acid), MCPB acid (4-(4-chloro-2-methylphenoxy)butanoic acid), mecoprop, diclofop, difenopenten, dichlorprop, fluazifop, quizalofop, fenoxaprop, haloxyfop, and clodinafop; oximes sych as fluxofenim; cyclohexyloximes such as clethodim; triazines such as atrazine, simozine, propazine, cyanazine, and prometryn; triazinones such as metribuzin; ureas such as rimsulfuron, nicosulfuron, linuron, diuron, tebuthiuron, fluometuron, and siduron; dinitroanilines such as oryzalin, prodiamine, isopropalin, trifluralin, and pendimethalin; nitriles such as bromoxynil, ioxynil, and diclobenil and the respective salts such as bromoxynil octanoate; diphenyl ethers such as ethoxyfen, acifluorfen, bifenox, fluoroglycofen, fomesafen, and oxyfluorfen; dithiocarbamates such as metam; carbamates such as asulam; carbanilates such as desmedipham and phenmedipham; pyridazinones such as norfluazon; pyridines such as dithiopyr, thiazopyr, triclopyr, clopyralid, picloram, and fluroxypyr; imidazolinones such as imazethapyr; aromatic acids such as dicamba; and unclassified herbicides such as clomazone, cinmethylin, acrolein, benazolin, bentazone, fluridone, and methazole. The herbicides are used individually or in mixtures of two or more herbicides in the composition.

Insecticides useful in compositions are exemplified by, but not limited to, carbamates such as carbaryl and methomyl; organophosphorus insecticides such as malathion, methyl parathion, acephate, dimethoate, fonofos, parathion, chlorpyrifos, and diazinon; pyrethroids such as cypermethrin, bifenthrin, permethrin, tefluthrin, bioresmethrin, resmethrin, allethrin, cyfluthrin, and deltamethrin; nicotinoids such as imidaclodrid; pyrazoles such as fipronil; and organochlorines such as endosulfan. The insecticides are used individually or as mixtures of two or more insecticides in the composition.

Fungicides useful in compositions are exemplified by, but not limited to, antibiotic fungicides such as azxystrobin and kresoxim-methyl; dithiocarbamates maneb and mancozeb; aliphatic nitrogen fungicides; amides; aromatic fungicides; benzimidazoles; benzimidazole precursors; carbamates; dicarboximides; dinitrophenols; thiocarbamates; dithiocarbamates; ureas; pyrimidines; quinolines; quinones; quinoxalines; various unclassified fungicides such as fenpropidin and piperalin; morpholines such as fenpropimorph and tridemorph; conazoles such as flusilazole, propiconazole, tebuconazole, and triadimefon; pyridines such as pyrifenox; thiazoles such as etridiazole; organophosphorous compounds such as phosdiphen; and imidazoles such as pefurazoate. The fungicides are used individually or as mixtures of two or more fungicides in the composition.

Surfactants

Surfactants useful in emulsifiable pesticide concentrates include, but are not limited to, non-ionic, anionic, cationic, amphoteric or zwitterionic surfactants with emulsifying properties. As used herein, the term “surfactant component” means one or more surfactants. Non-ionic surfactants useful in emulsifiable pesticide concentrates include, but are not limited to, polyethylene glycol surfactants, polyhydric alcohol surfactants, acetylene surfactants, alklyl glycosides, alkyl phenol ethoxylates, alcohol ethoxylates, sorbitan esters, alkyl polyglycosides, organo silicone surfactants, and other non-ionic surfactants customarily used in the agricultural chemical technology that are known to the person skilled in the art or that can be found in the relevant specialized literature.

Anionic surfactants are also useful in emulsifiable pesticide concentrates. Anionic surfactants include, but are not limited to, carboxylic acid surfactants and their salts, sulfate surfactants and their salts, sulfonic acid surfactants and their salts, phosphate surfactants and their salts, and other anionic surfactants customarily used in the agricultural chemical technology that are known to the person skilled in the art or that can be found in the relevant specialized literature.

Cationic surfactants are also useful in emulsifiable pesticide concentrates. Cationic surfactants include, but are not limited to, alkyl amine salts, alkyl quarternary ammonium salts, and other cationic surfactants customarily used in the agricultural chemical technology that are known to the person skilled in the art or that can be found in the relevant specialized literature.

Other surfactants also useful in emulsifiable concentrates include, but are not limited to, amphoteric surfactants such as betaine and amino acid surfactants, zwitterionic surfactants, silicone surfactants, and fluorochemical surfactants.

Although the function of an individual surfactant is dependent on the specific pesticide emulsion in which it is used, typical functions of some non-ionic surfactants are as follows. The ethoxylated nonionic surfactants function as primary emulsifiers. The sorbitan esters (not ethoxylated) function as both coupling agents and secondary emulsifiers. The alkyl polyglycosides function as compatibility agents for high electrolyte tank mixes. The organo silicones are used as superspreading surfactants.

Typical functions of anionic surfactants include, but are not limited to, acting as secondary emulsifiers, as compatibility agents for high electrolyte tank mixes, and as acidifying agents to reduce the pH of the spray mixes.

Other Components

Emulsifiable pesticide concentrates optionally comprise defoamers, for example, dimethyl siloxane. Emulsifiable pesticide concentrates also optionally comprise fatty acids and water, both of which function as coupling and clarifying agents to fully solubilize the emulsifier components into the finished emulsifiable pesticide concentrate. The fatty acids include, but are not limited to, oleic acid, linoleic acid, lauric acid, and mixtures of acids, such as tall oil. Emulsifiable pesticide concentrates also optionally comprise surfactants that are wetting agents and/or detergents.

Emulsifiable Pesticide Concentrate Compositions

The emulsifiable pesticide concentrate comprises a pesticide or mixture of pesticides, an aromatic fluid, a surfactant component, and, optionally, other components, such as a defoamer or additional solvent. The emulsifiable pesticide concentrate comprises from 1 weight % to 90 weight % pesticide; alternatively from 5 weight % to 80 weight % pesticide; alternatively from 10 weight % to 70 weight % pesticide; alternatively from 20 weight % to 60 weight % pesticide; alternatively from 30 weight % to 50 weight % pesticide. The emulsifiable pesticide concentrate further comprises from 1 weight % to 95 weight % aromatic fluid; alternatively from 5 weight % to 90 weight % aromatic fluid; alternatively from 10 weight % to 80 weight % aromatic fluid; alternatively from 20 weight % to 70 weight % aromatic fluid; alternatively from 30 weight % to 50 weight % aromatic fluid. The emulsifiable pesticide concentrate further comprises from 1 weight % to 25 weight % surfactant component; alternatively from 2 weight % to 20 weight % surfactant component; alternatively from 3 weight % to 15 weight % surfactant component; alternatively from 5 weight % to 12 weight % surfactant component; alternatively from 7 weight % to 10 weight % surfactant component. The emulsifiable pesticide concentrate further comprises from 0 weight % to 20 weight % other components; alternatively from 2 weight % to 15 weight % other components; alternatively from 3 weight % to 12 weight % other components; alternatively from 4 weight % to 10 weight % other components; alternatively from 5 weight % to 8 weight % other components. The weight % of the emulsifiable pesticide concentrate is based on the total weight of the pesticide, aromatic fluid, surfactant component, and other components.

Application and Preparation

As used herein, the term “effective amount” means an amount of a pesticide, a surfactant component, other components, or water effective to accomplish its intended purpose.

In one or more embodiments the method for inhibiting pests comprises combining a pesticide in an aromatic fluid having Formula I above to form a composition. The composition is blended with a surfactant component to form an emulsifiable pesticide concentrate. The emulsifiable pesticide concentrate is mixed with water to form a pesticide emulsion. The pesticide emulsion is applied to a crop.

In one or more embodiments the method of preparing a pesticide emulsion comprises mixing water with an emulsifiable pesticide concentrate. The emulsifiable concentrate comprises a surfactant component, a pesticide, and an aromatic fluid having Formula I above.

In one or more embodiments the method of applying a pesticide emulsion comprises dispersing the pesticide emulsion to a crop. The pesticide emulsion comprises a pesticide, an aromatic fluid having Formula I above, a surfactant component, and water.

The foregoing disclosure and description of the invention are illustrative and explanatory thereof, and various changes in the details of the illustrated composition and construction and method of operation may be made without departing from the spirit of the invention. Additionally, other operations involving the use of aromatic fluids include cleaning, printing, extraction processes, use in adhesives, sealants, cosmetics, drilling muds, coatings, and countless others.

### EXAMPLES

Test Methods

Kauri Butanol Value was determined by a variation of ASTM D-1133-02. In a 205 milliliter Erlenmeyer flask, 20 grams (±0.1 grams) of kauri-butanol solution was added. The flask was placed in a water bath at 20° C. (±1° C.). A 50-milliliter burette was filled with the solvent being tested. The standardized kauri-butanol solution was titrated with the solvent being tested until the end point was reached. A photocopy of the residence listings from a telephone book was used as the 10 point print sample placed directly beneath the water bath. The tester looked through the liquid at the print to observe the end point. The end point was reached when sharp outlines of the 10 point print were blurred or obscured, but were not illegible. The volume in milliliters of solvent added to the flask to produce turbidity was recorded. The kauri-butanol values were calculated using the following formula:
Kauri-Butanol value=[65(C−B)/(A−B)]+40 (1)
where A is the milliliters of toluene required to titrate 20 grams of kauri-butanol solution (the A factor should be on the certificate of analysis that accompanies the standardized kauri-butanol solution);
B is the milliliters of n-heptane-toluene blend required to titrate 20 grams of kauri butanol solution (the B factor should be on the certificate of analysis that accompanies the standardized kauri-butanol solution); and
C is the milliliters of solvent being tested that are required to titrate 20 grams of kauri-butanol solution.

The volume of solvent used was corrected to the standard temperature if the burette was maintained at a temperature other than 25° C. (±1° C.) using the following formula:
Correction, milliliters=C(25−T)*0.0009 (2)
where C is the milliliters of solvent under test required to titrate 20 grams of kauri-butanol solution; and
T is the temperature of the solvent in the burette, ° C.

Duplicate results in the range of 20 to 90 should be considered suspect if they differ more than the following amount (95% probability):
Repeatability=0.01K−0.1
Reproducibility=0.03K+1.0
where K is the average kauri-butanol value.

High kauri-butanol values (>108) may cause kauri gum to fall out of solution before the mixture becomes turbid, invalidating the values.

Aniline and Mixed Aniline Points were determined by a variation of ASTM D-611-82 (reapproved 1998). For the Aniline Points, 10 milliliters of aniline was added to a test tube. The test tube was fitted with a suitable stirrer and thermometer. The thermometer was centered in the test tube and some padding was kept at the base of the stand to avoid breakage of the test tube if it slipped. The thermometer bulb did not touch the side of the test tube and was vertically positioned in the middle of the liquid. Then, 10 milliliters of the sample being tested was added to the test tube containing aniline. If the sample was not miscible at room temperature, the mixture was allowed to cool below the first appearance of turbidity, the temperature at which the mixture suddenly became cloudy throughout, and the Aniline Point was recorded. If the sample was miscible at room temperature, heat was applied directly to the test tube with a heat gun. The heat gun was positioned outside the hood and 1 to 2 inches was kept between the bottom of the tube and the heat gun exhaust. The hood doors were positioned between the test tube and the heat gun to produce a small opening for the hot air flow. The mixture was continuously stirred rapidly using 2 inch strokes, avoiding introduction of air bubbles. The mixture was continuously heated until it cleared. The temperature rose at a rate of I to 3° C./min. until complete miscibility was obtained. The mixture was allowed to cool below the first appearance of turbidity and the Aniline Point was recorded.

For the Mixed Aniline Point, 10 milliliters of aniline was added to a test tube. The test tube was fitted with a suitable stirrer and thermometer. The thermometer was centered in the test tube and some padding was kept at the base of the stand to avoid breakage of the test tube if it slipped. The thermometer bulb did not touch the side of the test tube and was vertically positioned in the middle of the liquid. Added to the test tube containing aniline was 5 milliliters of sample and 5 milliliters of n-heptane. The test tube was placed into a cooling bath of isopropyl alcohol and dry ice. The mixture was continuously stirred rapidly using 2 inch strokes, avoiding introduction of air bubbles. The mixture was allowed to cool below the first appearance of turbidity and the Mixed Aniline Point was recorded.

Solubility was determined by adding a predetermined weight of pesticide to a vial and then adding the solvent to within 10 grams to make the appropriate concentrations. Several different concentrations were made. The range of suspected solubility was bracketed in 5 to 10 weight % intervals. The vials were capped and inverted several times to completely dissolve the pesticide. If the pesticide was not completely dissolved, the vials were placed in a beaker filled with warm water until the pesticide dissolved. The water was not heated closer than 30° C. of the flash point of the solvent being tested. The vial was removed from the heated beaker and was left to stand for 3 hours at room temperature. The vial was then placed into a chiller, an ethylene glycol bath, if a lower temperature was desired. The time was noted and the vials were checked for crystals; the time for vials placed into the chiller did not begin until the sample reached the desired temperature. If crystals were present, the solutions in the vials were diluted, the vials were inverted several times, the vials were either heated or cooled, and the vials were checked for crystals. The vials were allowed to stand for 24 hours and were then rechecked for crystals. If crystals were still absent after 24 hours, one crystal of pesticide was added to the vial (seeding) and the vial was inverted several times to assure the crystal was dissolved. The vial was left to stand for 48 hours and rechecked for crystals. If crystals were present, the solution was diluted further and the previous steps were repeated until no crystals appeared after seeding. If all samples tested resulted in no crystals, the solubility was higher than the range tested. The test was started again at the beginning with higher concentrations of the pesticide in the solvent. The highest concentration at which the pesticide did not crystallize out was reported as the solubility of the pesticide in the solvent tested at the temperature tested.

The freezing/melting point of heavy aromatics was determined by placing approximately 20 ml of the sample into a heat-resistant test tube that was fitted with a thermometer in the center. The sample was cooled in an isopropyl/dry ice bath. After the sample froze, the test tube was taken out of the bath and the sample was warmed gradually to room temperature. The freeze/melt point was determined to be the temperature at which the transition from solid to liquid occurred. The test was repeated a minimum of three times, and the results were averaged to give the freezing/melting point.

Sample Preparation and Testing

The aromatic fluid is prepared by hydroalkylation of the aromatic starting materials. The aromatic starting material is fed, along with hydrogen, over a solid catalyst. The catalyst typically has both acidic functionality and hydrogenation functionality. Preferred acidic components are zeolites, metal sulfates and mixed metal oxides. Preferred hydrogenation components include Group VIII metals, especially Pd and Ru, either alone or combined with other metals or metal oxides.

Catalyst Preparation

Three catalysts were used to prepare the aromatic fluids for the following examples. The base material for the first two catalysts was an iron tungsten zirconia material prepared by co-precipitation as disclosed in U.S. Pat. No. 6,124,232. The synthesis composition, in terms of the molar Fe/W/Zr ratio was approximately 0.12/1/7.1. Catalyst X was calcined at 700° C., and catalyst Y was calcined at 800° C. Palladium was added to these catalysts via impregnation with aqueous solution of palladium nitrate. Catalyst X had 0.3 weight % Pd, and catalyst Y had 0.6% Pd. The impregnated catalysts were dried and then calcined in air at 400° C.

Catalyst Z was made from a base consisting of an 80 weight %/20 weight % extrudate of zeolite MCM-49 and alumina. MCM-49 is described in U.S. Pat. No. 5,236,575. This base material was impregnated with an aqueous solution of palladium tetraamine nitrate, dried, and calcined in air at 360° C.

Production of Aromatic Fluids

A general procedure was followed to run each metal-containing catalyst for hydroalkylation. 2.0 grams of the catalyst being tested was charged to a fixed-bed micro-reactor, where the catalyst was pretreated with 50 cc/minute of flowing hydrogen for 2 hours at 300° C., and 1 atm (250 psig for sample E) pressure. After cooling the reactor to within 5° C. of the starting reaction temperature in flowing hydrogen, liquid was fed into the reactor through a syringe pump at 60 cc/hour for 1 hour while the reactor pressure was increased to the starting reaction pressure. The liquid feed rate was then reduced to 2 WHSV (weight hourly space velocity, (grams of feed/hour)/(grams of catalyst)) and hydrogen/hydrocarbon molar ratio was adjusted to approximately 1:1. The liquid feeds comprised toluene, purchased from J. T. Baker 9460-05 A.C.S. reagent grade; benzene, purchased from Sigma Aldrich, catalog #27,070-9, 99.9+% HPLC grade; xylene, purchased from Sigma Aldrich, catalog #29,632-5; or mixtures thereof. The temperatures and pressures for the runs used to supply products for the examples here are given below. Raw liquid products were collected in a cold product trap. The raw liquid products were distilled to remove most components below C₁₂ and above C₁₄, to give finished liquid products. These finished liquid products were analyzed off-line by gas chromatography, using an FID and a 60 m, 0.32 mm ID DB-1 capillary column with 3 micron film, and by mass spectrometry for product species identification. The gas chromatograph oven temperature program was 50° C., hold 4 minutes, 12° C./minute to 260° C., and hold for 49 minutes. Among the C₁₂ products, over 90% consisted of cyclohexylbenzene. The remaining C₁₂ products were mainly methylcyclopentylbenzene and bicyclohexyl. Most of the C₁₃ products comprised methylcyclohexylbenzene and cyclohexyltoluene, while the C₁₄ products comprised mainly methylcyclohexyltoluene. The C₁₆ products from xylene feed experiments were mainly dimethylcycloxylene and the C₁₈ products from benzene feed experiments were mainly dicyclohexylbenzene. Tables 1, 2, and 3 provide the reaction parameters and the resulting products after distillation.

TABLE 1
Reaction Conditions and Parameters

| | | | | | Reaction | Reaction |
|---|---|---|---|---|---|---|
| | | | | H₂/Hydrocarbon | Temp., | Pressure, |
| Sample | Catalyst | Feed | WHSV | molar ratio | ° C. | psig |
| A | X | Toluene | 2.0 | 1.2 | 140 | 400 |
| B | Y | Toluene | 2.0 | 1.2 | 120-140 | 150-400 |
| C | Y | 50/50 | 2.0 | 1.1 | 140 | 250 |
| | | mole %/mole % | | | | |
| | | Benzene/Toluene | | | | |
| D | Y | Benzene | 2.0 | 1.0 | 120-140 | 150-250 |
| E | Z | 80/20 | 2.0 | 1.0 | 140-144 | 250 |
| | | weight %/weight % | | | | |
| | | Benzene/Toluene | | | | |
| F | Y | Xylene | 2.0 | 1.36 | 140 | 250 |

TABLE 2
Concentrations of Liquid Products in Weight %

| Sample | Feed | C₁₁₋ | C₁₂ | C₁₃ | C₁₄ | C₁₅₊ |
|---|---|---|---|---|---|---|
| A | Toluene Feed | | 0.1% | 0.3% | 98.0% | 1.6% |
| B | Toluene Feed | | 0.1% | 0.2% | 98.9% | 0.8% |
| C | 50 mole %/50 | 0.3% | 20.7% | 65.9% | 11.5% | 1.6% |
| | mole % Benzene/ | | | | | |
| | Toluene Feed | | | | | |
| D | Benzene Feed | 0.1% | 99.3% | 0.2% | | 0.4% |
| E | 80 weight %/ | 0.1% | 71.8% | 27.2% | 0.7% | 0.2% |
| | 20 weight % | | | | | |
| | Benzene/ | | | | | |
| | Toluene Feed | | | | | |

TABLE 3
Concentrations of Liquid Products in Weight %

| Sample | Feed | C₇₋ | C₈ | C₉₋₁₅ | C₁₆ | C₁₇₊ |
|---|---|---|---|---|---|---|
| F | Xylene Feed | 0.6% | 67.9% | 0.2% | 30.7% | 0.6% |

The liquid products were tested for solubility properties using the above identified test methods. The solubility results are given below in Tables 4, 5, and 6. Examples 1-17 in Table 4 and Examples 1-2, 5-6, and 14-17 in Table 5 are comparative examples of current available solvents. Examples 18 through 21 in Table 6 are the finished liquid products obtained after distillation. Example 22 in Table 6 is a mixture of Sample E and cyclohexylbenzene available from Sigma Aldrich. Enough cyclohexylbenzene was added to Sample E to result in an aromatic fluid mixture having approximately 80 weight % C₁₂ compounds and 20 weight % C₁₃ compounds (with some impurities or by-products from the reaction process). Example 23 in Table 6 is a mixture of Sample D and some heavier by-products obtained from the distillation of Sample D. The heavier by-products consisted mainly of C₁₈ compounds. Enough of the heavier by-products was added to Sample D to result in an aromatic fluid mixture having approximately 85 weight % C₁₂ compounds and 15 weight % heavier by-products (with some impurities or by-products from the reaction process). The aromatic fluids may also undergo the further processing step of oxidation with similar solubility results. The solubility of Examples 1 through 23 were tested using the above identified solubility test method, and Examples 1-2, 5-6, and 14-18 were also tested using the Kauri-butanol test method and the Aniline or Mixed Aniline Point test method, identified above.

TABLE 4
Comparative Samples: Solubility in Weight %

| | | | | | Bromoxynil | |
|---|---|---|---|---|---|---|
| Ex.# | Solvent | Trifluralin | Permethrin | Chlorpyrifos | Octanoate | Pendimethalin |
| 1 | Aromatic 150 | 65 | 65 | 75 | 70 | 50 |
| 2 | Aromatic 200 | 65 | 75+ | 75 | 75 | 50 |
| 3 | Phenyl | 59 | 65 | 70 | 70 | 55 |
| | Cyclohexanone/A200 | | | | | |
| | Blend: 56/44 | | | | | |
| 4 | Bibenzyl- | 60 | 60 | 70 | 65 | 50 |
| | phenyltoluene- | | | | | |
| | biphenyl Blend | | | | | |
| 5 | 5-ter-Butyl-m-Xylene | 50 | 65 | 65 | 61 | 35 |
| 6 | Aromatic 100 + iC₄ | 40 | 60 | 55 | 50 | 25 |
| 7 | Ethyl (S)-(−)-Lactate | 45 | 50 | 55 | 40 | 20 |
| 8 | Dipentene | 50 | 75 | 65 | 60 | 30 |
| 9 | Methyl Soyate | 40 | 55 | 50 | 45 | 25 |
| 10 | 1-Methyl-2- | 70 | 75 | 80 | 75 | 55 |
| | Pyrrilidinone | | | | | |
| 11 | Monopentylindan | 35 | 65 | 60 | 50 | 25 |
| 12 | Dipentylindan | <15 | 50 | 40 | 25 | <15 |
| 13 | Jurong Solvesso 200 | 60 | 65 | 75 | 70 | 55 |
| 14 | Exxsol D 130 | 10 | 10 | 15 | 10 | 5 |
| 15 | Isopar M | 10 | 10 | 10 | 10 | 5 |
| 16 | Norpar 14 | 7 | <5 | 20 | 10 | 5 |
| 17 | Dodecyl Benzene | 25 | 45 | 50 | 40 | 20 |

TABLE 5
Comparative Samples: Kauri-butanol and Aniline or Mixed Aniline
Points

| Ex. | | Kauri-Butanol | Aniline Point | Mixed Aniline |
|---|---|---|---|---|
| # | Solvent | Value | (° C.) | Point (° C.) |
| 1 | Aromatic 150 | 93 | | 16 |
| 2 | Aromatic 200 | 99 | | 12 |
| 5 | 5-ter-Butyl-m- | 66 | | 28 |
| | Xylene | | | |
| 6 | Aromatic 100 + iC₄ | 51 | 23 | |
| 14 | Exxsol D 130 | 23 | 89 | |
| 15 | Isopar M | 25 | 89 | |
| 16 | Norpar 14 | 20 | 91 | |
| 17 | Dodecyl Benzene | 36 | | 43 |
| 18 | Sample D | 88 | | 13 |

TABLE 6
Aromatic Fluids: Solubility in Weight %

| | | | | | Bromoxynil | |
|---|---|---|---|---|---|---|
| Ex.# | Solvent | Trifluralin | Permethrin | Chlorpyrifos | Octanoate | Pendimethalin |
| 18 | Sample D | 60 | 65 | 70 | 65 | 45 |
| 19 | Sample A | 45 | | | 55 | 35 |
| 20 | Sample B | 50 | 70 | 65 | 55 | 35 |
| 21 | Sample C | 60 | 55 | 65 | 65 | 45 |
| 22 | Sample E + cyclohexylbenzene | 60 | 65 | 70 | 65 | 45 |
| | to | | | | | |
| | form an ˜80 weight % | | | | | |
| | C₁₂/˜20 weight % C₁₃ | | | | | |
| | mixture | | | | | |
| 23 | Sample D + heavy | 60 | 60 | 70 | 65 | 40 |
| | products to form an ˜85 | | | | | |
| | weight % C₁₂/15 weight | | | | | |
| | % heavier by-products | | | | | |

The liquid products were tested for freezing/melting point properties. Examples 22 and 23 were the mixtures as stated above. Examples 24 through 26 were mixtures of cyclohexylbenzene available from Sigma Aldrich and the product of Sample C above. Mixtures of 10 weight % Sample C and 90 weight % cyclohexylbenzene, 20 weight % Sample C and 80 weight % cyclohexylbenzene, and 50 weight % Sample C and 50 weight % cyclohexylbenzene were tested. Example 27 was 100 weight % cyclohexylbenzene. Example 28 was Sample E above. Examples 22 through 28 were tested using the above identified test method. The freezing/melting point results are provided below in Table 7.

TABLE 7
Freezing/Melting Point Properties

| Ex. # | Solvent | Freezing/Melting Point (° C.) |
|---|---|---|
| 22 | Sample E + cyclohexylbenzene to | −7 |
| | make an ˜80 weight % C₁₂/˜20 | |
| | weight % C₁₃ mixture | |
| 23 | 85 weight % Sample D and 15 | 6 |
| | weight % heavier by-products | |
| 24 | 10 weight % Sample C/90 weight | 2 |
| | % Cyclohexylbenzene | |
| 25 | 20 weight % Sample C/80 weight | −4 |
| | % Cyclohexylbenzene | |
| 26 | 50 weight % Sample C/50 weight | −20 |
| | % Cyclohexylbenzene | |
| 27 | Cyclohexylbenzene | 6 |
| 28 | Sample E | −11 |

1. A composition comprising:
a pesticide, and
an aromatic fluid comprising a chemical composition described by Formula I: 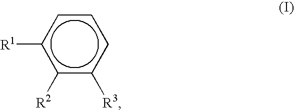
wherein R¹ is
a cycloalkyl group having from 4 to 10 carbon atoms and
optionally having one or more alkyl group substitutions each having from 1 to 4 carbon atoms;
R² is
a hydrogen, or
an alkyl group having from 1 to 4 carbon atoms; and
R³ is
a cycloalkyl group having from 4 to 10 carbon atoms and
optionally having one or more alkyl group substitutions each having from 1 to 4 carbon atoms,
a hydrogen, or
an alkyl group having from 1 to 4 carbon atoms.

2. The composition of claim 1 wherein the aromatic fluid has a freezing/melting point from −20 to 2° C.

3. The composition of claim 2 wherein the aromatic fluid has a freezing/melting point from −11 to −4° C.

4. The composition of claim 3 wherein the aromatic fluid has a freezing/melting point from −7 to −4° C.

5. The composition of claim 1 wherein the aromatic fluid comprises:
50 weight % or more of at least one of C₁₂, C₁₃, and C₁₄ compounds,
1 weight % or less C₁₁₋ compounds, and
2 weight % or less C₁₅₊ compounds,
based on the total weight of the aromatic fluid.

6. The composition of claim 5 wherein the aromatic fluid comprises:
20 weight % or more C₁₂ compounds,
65 weight % or more C₁₃ compounds, and
10 weight % or more C₁₄ compounds,
based on the total weight of the aromatic fluid.

7. The composition of claim 5 wherein the aromatic fluid comprises:
70 weight % or more C₁₂ compounds, and
20 weight % or more C₁₃ compounds,
based on the total weight of the aromatic fluid.

8. The composition of claim 5 wherein the aromatic fluid comprises at least one of cyclohexylbenzene, methylcyclohexylbenzene, dimethylcyclohexylbenzene, cylcohexyltoluene, methylcyclohexyltoluene, dimethylcyclohexylxylene, and dicyclohexylbenzene.

9. The composition of claim 1 wherein the aromatic fluid comprises:
90 weight % or less of at least one of C₁₂, C₁₃, and C₁₄ compounds,
70 weight % or less C₁₁₋ compounds, and
5 weight % or more C₁₅₊ compounds,
based on the total weight of the aromatic fluid.

10. The composition of claim 9 wherein the aromatic fluid comprises:
30 weight % or more C₁₅₊ compounds, and
69 weight % or less C₁₁₋ compounds,
based on the total weight of the aromatic fluid.

11. The composition of claim 9 wherein the aromatic fluid comprises:
15 weight % or more C₁₅₊ compounds, and
80 weight % or less C₁₂ compounds.

12. The composition of claim 9 wherein the aromatic fluid comprises at least one of cyclohexylbenzene, methylcyclohexylbenzene, dimethylcyclohexylbenzene, cylcohexyltoluene, methylcyclohexyltoluene, dimethylcyclohexylxylene, and dicyclohexylbenzene.

13. The composition of claim 1 wherein the pesticide comprises one or more of a herbicide, insecticide, fungicide, or mixtures thereof.

14. The composition of claim 13 wherein the herbicide is selected from the group consisting of pendimethalin, trifluralin, bromoxynil octanoate, propanil, and mixtures thereof.

15. The composition of claim 13 wherein the insecticide is selected from the group consisting of chlorpyrifos, permethrin, and mixtures thereof.

16. The composition of claim 1 further comprising a surfactant component in an effective amount to form an emulsifiable pesticide concentrate.

17. The composition of claim 16 wherein the surfactant component comprises from 1 weight % to 25 weight % based on the total weight of the emulsifiable pesticide concentrate.

18. The composition of claim 16 further comprising water in an effective amount to form a pesticide emulsion.

19. A method for inhibiting pests, the method comprising blending the composition of claim 1 with a surfactant component to form an emulsifiable pesticide concentrate; mixing the emulsifiable pesticide concentrate with water to form a pesticide emulsion; and applying the pesticide emulsion to a crop.

20. The method of claim 19 wherein the pesticide comprises one or more of a herbicide, insecticide, fungicide, or mixtures thereof.

21. A method of preparing a pesticide emulsion comprising mixing water with an emulsifiable pesticide concentrate that comprises a surfactant component and the composition of claim 1.

22. The method of preparing the pesticide emulsion of claim 21 wherein the pesticide comprises one or more of a herbicide, insecticide, fungicide, or mixtures thereof.

23. A method of treating a crop comprising dispersing a pesticide emulsion that comprises the composition of claim 1, a surfactant component, and water onto a crop.

24. The method of applying the pesticide emulsion of claim 23 wherein the pesticide comprises one or more of a herbicide, insecticide, fungicide, or mixtures thereof.
